(19) United States
(12) Patent Application Publication
(10) Pub. No.: US 2007/0179277 A1
(43) Pub. Date: Aug. 2, 2007

(54) Rosin ester with low color and process for preparing same

(76) Inventor: Anthony J. Dallavia, Grayslake, IL (US)

Correspondence Address: HEXION SPECIALTY CHEMICALS, INC., 1600 SMITH STREET, P.O. BOX 4500, HOUSTON, TX, 77210-4500, US

(21) Appl. No.: 11/701,217

(22) Filed: Feb. 1, 2007

Related U.S. Application Data
(60) Provisional application No. 60/764,692, filed on Feb. 2, 2006.

(51) Int. Cl. C09F 1/00

(52) U.S. Cl. 530/210

(57) ABSTRACT

A process for producing light color rosins ester resin, preferably based on tall rosin, is described. The process is conducted in the presence of less than 10 weight % of an acid functional organic compound and avoids the need for use of a stoichiometric excess of rosin acid, or a stoichiometric excess of polyol hydroxyl groups. The process allows for the use of lower colored or darker tall oil rosin in the production of low color rosin esters.

### RELATED APPLICATION DATA

This application claims the benefit of U.S. Provisional Application Ser. No. 60/764,692 filed Feb. 02, 2006, the entire contents of which are hereby incorporated by reference.

### FIELD OF THE INVENTION

This invention relates to a process for preparing light color rosin esters, preferably based on tall oil rosin. Specifically, the esterification reaction is conducted in the presence of less than 10 weight % of an acid functional organic compound, and avoids the need for use of a stoichiometric excess of rosin acid, or of a stoichiometric excess of polyol hydroxyl groups. The process of the invention allows for the use of lower colored or darker tall oil rosin than would normally be used to make a low color rosin ester. Light colored rosin esters are highly desired as tackifier resins in hot melt adhesives and as binder resins in low color printing inks.

### BACKGROUND OF THE INVENTION

The production of various rosin esters have been described by many patents over the last eighty years. A frequently expressed need is the ability to produce light or low color rosin esters with an acceptable balance of properties such as acid number, melting point, viscosity and color stability. In addition, there has always been the need to control the cost of making such resins for successful commercialization. A significant aspect of which is the cost of the various raw materials such as tall oil rosin, various polyols, catalysts, bleaching agents, and stabilizers, which have increased substantially, due to energy and petrochemical feed stock costs. The cost increase is especially true for tall oil rosin, the availability of which has decreased.

Tall oil rosin is the major ingredient in the production of rosin esters, consequently the quality, cost and availability of tall oil rosin are critical factors in commercializing rosin esters. Manufacturing sites which produce rosin esters and other rosin resins are often located at some distance from the tall oil rosin refinery. When this occurs, the method of rosin transportation, and its affect on rosin cost and rosin color, becomes an important factor in producing and commercializing low color rosin esters.

Commonly, tall oil rosin, intended for rosin ester resin production, is shipped from the refinery as a molten liquid in bulk truck or by bulk rail. For the production of low color rosin esters, it is generally preferred that the rosin arrive at its final destination while still molten. However this is not always possible, as the transportation time involved may cause the rosin to solidify while in transit. Once solid, rosin requires re-melting for it to be used in ester production. Re-melting a large bulk shipment of tall oil rosin (e.g., 120,000 pounds or more) invariably increases rosin color formation due to thermal and oxidative degradation and uneven heat transfer. The degree to which rosin color increases upon re-melting is greatly affected by the conditions of the re-melting process. Such conditions include the degree to which an inert atmosphere, such as nitrogen gas, is effectively used during the entire re-melting process. Gardner color of the starting tall oil rosin is directly proportional to the color of the rosin ester produced; in general, the darker the starting rosin, the darker the rosin ester produced.

As the distance for shipping molten tall oil rosin increases, shipment by rail is preferred due to its lower cost than to shipment by truck. Due to the vagaries of rail shipment, the amount of time required can vary from less than one week to four weeks or even longer. Shipping delays can result in rosin solidification while still in the railcar and the subsequent need to re-melt the rosin. This is especially problematic in the winter months. It is not uncommon for tall oil rosin color to increase from two to six Gardner color units from its initial color value at the refinery to its final color just prior to its use in making rosin esters. This increase in rosin color makes it especially difficult, if not impossible, to make rosin ester resins with a sufficiently low color for hot melt adhesive applications and for printing ink applications which require low resin color.

Major applications for low color rosin esters include use as tackifier resins in hot melt adhesives and as binding resins in low color, overprint varnishes used in the printing, for example, high gloss magazines, advertising and corporate annual reports. Typical low color rosin esters compositions for adhesives are prepared from rosin, catalyst(s), bleaching agent(s), polyhydric alcohol(s) also as known as a polyols, and a stabilizer and/or antioxidant. Such catalyst, stabilizers and/or bleaching agents are known is the art as described, for example, in U.S. Pat. Nos. 2729660, 3310575, 3423389, 3780013, 4172070, 4548746, 4690783, 4693847, 4725384, 4744925, 4788009, 5021548 and 5049652.

Typical low color rosin esters compositions for printing additionally include the use of alpha, beta-unsaturated carboxylic acids, esters, and anhydrides, and their half-esters, as described in U.S. Pat. No. 4,751,025, incorporated herein by reference. Such unsaturated carboxylic acids include, mono-carboxylic acids such as acrylic acid and methacrylic acid, crotonic acid; alpha, beta-unsaturated polycarboxylic acids such as fumaric acid, maleic acid, citraconic acid, mesaconic acid, aconitic acid and itaconic acid; the available anhydrides of the above acids, such as maleic anhydride, alkyl esters and half esters of the above acids, wherein the alkyl group is typically monomethyl, monoethyl, dimethyl, diethyl and mixtures thereof.

Although rosin ester resins used in making hot melt adhesives and overprint varnishes share the same need for low color, they can have different requirements for other properties such as, for example, softening point, viscosity, solubility and cost requirements. U.S. Pat. No. 5,120,781, for example, utilizes aromatic diacids to increase the softening point and achieve the desired tack properties required for hot melt adhesive applications, wherein the softening point was lowered due to the presence of excess polyol.

Various prior art methods to obtain low color and even colorless rosin esters include elaborate purification and isomerization processes as disclosed, for example, in U.S. Pat. Nos. 5,387,669 and 4,962,182. These process conditions are time and energy consuming and therefore increase the cost of producing such resins. Moreover, the degree of purification and isomerization can render rosin less reactive to further chemical modification and, as a result, limits its utility for producing printing ink resins which require additional reaction steps beyond esterification.

The combined use of an esterification catalyst with an equivalent excess of the polyol, such as, for example in U.S. Pat. No. 4,659,514 or in U.S. Pat. No. 5,049,652, can also lower rosin ester color. However, the residual excess of polyol can also adversely affect other rosin ester properties such as melt viscosity and ink oil solubility and therefore may not be as suitable for other industrial applications, such as in the production of specialized printing ink resins used in overprint varnishes.

Other prior art methods to produce low color rosin esters utilize an equivalent excess of rosin in the formulation such as described in, for example, U.S. Pat. No. 4,758,379. However, in adhesive and printing ink applications, residual un-reacted rosin can have undesired effects both in processing and in final resin properties. To solve this drawback, U.S. Pat. No. 5,830,992 has reduced the rosin excess utilized, but because of the rosin excess, a greater degree of stripping is required to lower the acid number of the rosin ester to maintain desirable adhesion. These processes suffer from additional process steps which are both time and energy consuming. The combined effects of polyol and tall oil price increases and reduced tall oil rosin availability, render the use of polyol and rosin excesses in rosin ester formulations less desirable due to the adverse effect on rosin ester economics.

By contrast, the present invention allows for the production of light color rosin esters while avoiding the above mentioned drawbacks due to the use of excess rosin or polyol in the rosin ester formulation. Additionally, the present invention allows for the use of lower color tall oil rosin, which has the advantage of being typically less costly than light color rosin.

### SUMMARY OF THE INVENTION

In one embodiment, there is provided a process to produce a rosin ester resin including the steps of first combining a molten rosin with a polyol, having hydroxyl functionality, then with an amount of 0.5 to 10 weight %, by weight of all reactants, of an acid functional organic compound selected from aromatic monofunctional acids, aromatic polyfunctional acid, aliphatic monoflnctional, aliphatic polyfunctional acids, natural fatty acids, synthetic fatty acids, polymerized rosin, rosin resin, and combinations thereof, wherein the reactant mixture does not contain a stoichiometric excess of hydroxyl functionality.

In another embodiment, there is provided a process to produce a rosin ester resin including the steps of first combining a molten rosin with an alpha,-beta unsaturated carboxylic acid, then with a polyol having hydroxyl functionality, then with an amount of 0.5 to 10 weight %, by weight of all reactants, of an acid functional organic compound selected from the group consisting of aromatic monofunctional acids, aromatic polyfunctional acid, aliphatic monofunctional, aliphatic polyfunctional acids, natural fatty acids, synthetic fatty acids, polymerized rosin, rosin resin, and combinations thereof, wherein the final reaction mixture does not contain a stoichiometric excess of hydroxyl functionality.

### DETAILED DESCRIPTION OF THE INVENTION

The process for making the rosin esters of the present invention includes contacting a molten rosin with a polyhydric alcohol, also known as a polyol, in the presence of an acid functional organic compound. In a preferred embodiment the process reactants include a phosphonate stabilizer/catalyst and a phenyl sulfide compound.

Suitable examples of rosins useful in the process of the invention include but are not limited to gum rosin, wood rosin or tall rosin or any subsets or mixtures thereof. The preferred rosin is tall rosin which is an isomeric mixture primarily composed of C₂₀ fused-ring, monocarboxylic acid hydrocarbons typified by levopimaric and abietic acids. Tall oil rosin is available commercially, for example, from Eastman Chemical Company under the trademark PAMITE. Prior to use in the process of the invention, the rosin may have been subjected to, for example, distillation, disproportionation, hydrogenation or polymerization and other treatments well known in the art. In the present invention, the amount of rosin used will vary depending on the end use application.

In general, the rosin is initially charged to a reaction vessel, with continuous agitation and under an inert nitrogen blanket. To produce rosin esters with the lowest color possible, the reaction vessel must contain an inert, non-oxidizing atmosphere through out the entire process. If solid rosin is used, the melting temperature will be in the range 150° C. to 190° C., preferably 160° C. to 180° C.

After the rosin is melted, and if a printing ink resins is being made, a alpha,-beta unsaturated carboxylic acid, for example, fumaric acid or maleic anhydride is charged to the reactor and the temperature increased to the range 180° C. to 220° C. or preferably in the range 190° C. to 210° C. or more preferably in the range 195° C. to 205° C. These conditions result in a Diels-Alder reaction which occurs primarily between the PAN (Palustric, Abietic and Neoabietic) acids of rosin and an unsaturated acid. Sometimes this reaction is run at atmospheric pressure, other times the reactor is sealed and the pressure may increase from 5 to 15 psi. The PAN acid content of rosin will vary depending on the source and type of rosin used.

After the rosin has melted or the Diels-Alder reaction described above is complete, the batch temperature will be typically adjusted to the range 180° C. to 200° C., preferably 185° C. to 195° C. and a metal phosphonate stabilizer/catalyst and phenol sulfide compound are added. A preferred stabilizer/catalyst for low color rosin esters is disclosed in U.S. Pat. No. 3,310,575, incorporated herein by reference, as composed of calcium bis-monoethyl(3,5-di-tert-butyl-4-hydroxybenzyl)phosphonate, and described as metal derivatives of hindered mono or dibasic phenol substituted phosphonic acids. Such a material is commercially available from Ciba-Geigy under the trademark IRGAMOD 195. Various phenol sulfide bleaching and rosin disproportion agents are described in U.S. Pat. No. 3,780,013, incorporate herein by reference. In the method of the present invention, nonylphenol disulfide is preferred. This material is commercially available from Albemarle Corporation under the trademark ETHANOX 323.

The phenol sulfide compound is added to the reaction mixture in amounts from 0.05 wt % to 1.0 wt % , preferably in the 0.20 wt % to 0.6 wt % and more preferably 0.30 wt % to 0.50 wt % all based on the total weight of reactants. It is noted that, at this stage, the phenol sulfide compound can be added all at once or may be added incrementally in “shots” as the esterification step proceeds. The metal phosphonate stabilizer/catalyst is added in amounts from 0.05 wt % to 0.50 wt % , preferably in the 0.10 wt % to 0.40 wt % and more preferably 0.20 wt % to 0.30 wt % based on the total weight of reactants.

In the preferred process, the polyol is added in the temperature range from 185° C. to 210° C., preferably from 195° C. to 205° C. after the phenol sulfide and metal phosphonate have been charged to the reactor and thoroughly dispersed. Any polyols or polyhydric alcohols may be utilized. Suitable examples of polyols useful in the process of the invention include but are not limited to ethylene glycol, diethylene glycol and higher homologues, glycerol, mono-pentaerythritol, tech-pentaerythritol, dipentaerythritol, trimethylolethane, trimethylolpropane, manitol, sorbitol or any subsets or mixtures thereof. The preferred polyols are glycerol and pentaerythritol and the most preferred is mono-pentaerythritol. The amount and type of polyol used depends on the desired rosin ester composition and desired properties. In this process, the preferred polyol is used with an excess of acid equivalents.

After the polyol has been added to the reaction mixture, and while heating up to the top reaction temperature, an acid functional organic compound is charged to the reactor. Suitable examples of acid functional organic compounds useful in the process of the invention include but are not limited to aromatic monofunctional acids, aromatic polyfunctional acid, aliphatic monofunctional, aliphatic polyfunctional acids, natural and synthetic fatty acids, or polymerized rosin, rosin resins or any subset or mixture of the before mentioned acid functional organic compounds.

In one embodiment, the acid functional organic compound is an aromatic dicarboxylic acid utilized at a concentration of more than 0.5 and less than 10 weight % on the stoichiometric amount of the rosin engaged in the esterification. In another embodiment, the acid functional organic compound is an aromatic diacids, which can be used in a concentration of more than 0.5 and less than 10 weight % on the stoichiometric amount of the rosin engaged in the esterification. Suitable examples of aromatic diacids include, but are not limited to phthalic acid, isophthalic acid, terephthalic acid or any subset or mixture thereof. The most preferred aromatic diacid is isophthalic acid.

In another embodiment, the acid functional organic compound is a monocarboxylic aromatic acid. Suitable examples of monocarboxylic aromatic acid include but are not limited to benzoic acid, 2-methylbenzoic acid, 3-methylbenzoic acid, 4-methylbenzoic acid, 2-ethylbenzoic acid, 3-ethylbenzoic acid, 4-ethylbenzoic acid and the like, salicylic acid, 4-hydroxy benzoic acid, 1-naphtoic acid, and the like, or any subset or mixture thereof. Of these organic acids, preferred are benzoic acid and alkyl substituted benzoic acid. The most preferred is benzoic acid. The acid concentration is from 0.5 to less than 10 weight % and the most preferred concentration is between 1.0 and 3.5 weight %.

In another embodiment, the acid functional organic compound is an aliphatic monocarboxylic acid having a boiling point above 160° C. (at atmospheric pressure) such as butanoic acid, pentanoic acid, pivalic acid, hexanoic acid and higher homologues such as neodecanoic acid, which is commercially available from Hexion Specialty Chemicals, Inc. under the trademark VERSATIC or any subset or mixture thereof. The most preferred is VERSATIC acid. The acid concentration is from 0.5 to less than 10 weight % and the most preferred concentration is between 1.0 and 5.0 weight %. The excess in acid can be achieved by additional rosin in a weight excess of less than 5% and preferably from 1 to 3.5 weight %.

In another embodiment, the acid functional organic compound is an aliphatic dicarboxylic acid with a boiling point above 160° C. Suitable examples of which include succinic acid, glutaric acid, adipic acid, pimelic acid, dimer fatty acid and the like or any subset or mixture thereof. The preferred are succinic, glutaric and adipic acids. The most preferred is succinic acid. The acid concentration is from 0.5 to less than 10 weight % and the most preferred concentration is between 1.0 and 5.0 weight %.

Besides the distinct advantage of allowing for the production of low color rosin esters, the use of the above organic acids provide a further benefit in that properties of the rosin ester such as softening point, viscosity and solubility can be adjusted over a broad range and allows for enhanced resin properties for different end-use applications. The rosin ester of this invention is produced via esterification of rosin and one or more polyols in the presence of less than 10 weight percent of an acid functional organic compound.

The rosin-polyol esterification reactions can be conducted in the range of 220° C. to 280° C., preferably in the range of 260° C. to 280° C. and more preferably in the range 270° C. to 280° C. being the top reaction temperature and is conducted in an inert atmosphere, such as for example, nitrogen. Once at the top reaction temperature, processing of rosin esters frequently involves the use of sub-surface nitrogen or steam and/or vacuum as a means of inhibiting color body formation or removing various color bodies which may form during the rosin ester reaction. The sub-surface use of nitrogen or steam is also known as a sparge. These process steps may be used individually or in combination depending on processing and product requirements as is known in the art. These steps also accelerate the resin forming reaction by facilitating the removal of water, which is the primary by-product of rosin polyol esterification, which is also well known in the art.

Process times for this invention vary depending on the particular formula chosen, top reaction temperature and the desired acid number. In general, process cycle times for rosin esters of this invention vary from greater than 1 hour, preferably from about 5 to about 50 hours, more preferably 15 to 45 hours, more preferably from 20 to 35 hours and even more preferably from 25 to 30 hours.

In a preferred embodiment, the process of the invention produces rosin esters for use in adhesive formulations. The process combines a rosin, preferably a tall oil rosin, a catalyst including metal derivatives of hindered mono or dibasic phenol substituted phosphonic acids, a phenyl sulfide, preferably nonylphenol disulfide, a polyol, preferably glycerol, pentaerythritol or mono-pentaerythritol, and an acid functional organic compound, preferably, succinic acid, glutaric acid, adipic acid or pimelic acid. In another embodiment, the process of the invention produces rosin esters, for use in adhesive formulations, having a Gardner color number less than the Gardner number of the rosin.

In a more preferred embodiment, the process of the invention produces rosin esters for use in adhesive formulations, where based upon the weight of all reactants, the rosin is present in an amount of from 82 to 92 weight %, the catalyst is present in an amount of from 0.1 to 0.3 weight %, the phenyl sulfide is present in an amount of from 0.1 to 0.4 weight %, the polyol is present in an amount of from 8 to 11 weight %, and the acid functional organic compound comprises succinic acid, and is present in an amount of 1 to 3 weight %.

In one embodiment, the neat rosin esters, for use in adhesive formulations, produced by the process of the invention exhibit a color improvement over the neat starting rosin, Δ Color, of greater than 2, preferably between 2 and 6. In another embodiment, the acid number of rosin ester produced by the process of the invention is less then 15, preferably between 10 and 15. In another embodiment, the rosin esters produced by the process of the invention have softening point of between 80 and 110 and preferably between 85 and 105.

In a preferred embodiment, the process of the invention produces rosin esters for use in ink formulations. The process combines a rosin, preferably a tall oil rosin, an alpha,-beta unsaturated carboxylic acid, preferably fumaric acid, a catalyst including metal derivatives of hindered mono or dibasic phenol substituted phosphonic acids, a phenyl sulfide, preferably nonylphenol disulfide, a polyol, preferably glycerol, pentaerythritol or mono-pentaerythritol, and an acid functional organic compound, preferably succinic acid, glutaric acid, adipic acid or pimelic acid. In another embodiment, the process of the invention produces rosin esters, for use in ink formulations, having a Gardner color number less than the Gardner number of the rosin.

In a more preferred embodiment, the process of the invention produces rosin esters for use in ink formulations, where based upon the weight of all reactants, the rosin is present in an amount of from 75 to 80 weight %, the alpha,-beta unsaturated carboxylic acid is present in an amount of 6 to 9 weight %, the catalyst is present in an amount of from 0.1 to 0.3 weight %, the phenol sulfide is present in an amount of from 0.2 to 0.4 weight %, the polyol is present in an amount of from 10 to 14 weight % and the acid functional organic compound comprises adipic acid, and is present in an amount of 1 to 3 weight %.

In one embodiment, the neat rosin esters, for use in ink formulations, produced by the process of the invention exhibit a color improvement over the neat starting rosin, Δ Color, of greater than 1, preferably between 2 and 6. In another embodiment, the acid number of rosin ester produced by the process of the invention is less then 30, preferably less than 25, and more preferably between 15 and 25. In another embodiment, the rosin esters produced by the process of the invention have softening point of between 120 and 170, preferably between 140 and 160 and more preferably 145 and 155.

In order to provide a better understanding of the present invention including representative advantages thereof, the following examples are offered. It is understood that the examples are for illustrative purposes and should not be regarded as limiting the scope of the invention to any specific materials or conditions.

### EXAMPLE 1 (COMPARATIVE)

Using a sample of Pamite 90 (Eastman Chemicals) tall oil rosin, with a Gardner color (neat) of 8.3 and an acid number of 173.0, 1960.9 grams was charged into a standard 3 liter glass reactor and melted at 170° C. under nitrogen blanket. Once the rosin was melted, 5.9 grams of Ethanox 323(Albemarle) and 4.7 grams of Irgamod 195(Ciba-Geigy) were also charged. The mixture was then heated to 200° C. where 216.4 grams of monopentaerythritol was added. After this addition, the batch was heated to 270° C. and a nitrogen sparge applied. The batch was held at this temperature until the acid number was less than 14. Thirty minutes prior to discharging the batch two antioxidants were added, 5.0 grams of Irganox 565 (Ciba-Geigy) and 13.3 grams of distearyl-thio-dipropionate (Structol). On an equivalent basis, the hydroxyl/acid ratio in this example is equal to 1.050.

### EXAMPLE 2 (COMPARATIVE)

Using rosin from the same lot of Pamite 90 as Example 1, 1953.6 grams of Pamite 90 was charged to a 3 liter reactor and melted at 170° C. under nitrogen. After melting the rosin, 5.9 grams of Ethanox 323 and 4.7 grams of Irgamod 195 were added and the mixture again heated to 200° C. At 200° C., 200.2 grams of monopentaerythritol was added and the batch heated to 270° C. under nitrogen sparge. The batch was again held at 270° C. until the acid number was less than 14. Thirty minutes prior to discharging the batch two antioxidants were added, 5.0 grams of Irganox 565 (Ciba-Geigy) and 13.3 grams of distearyl-thio-dipropionate (Structol). In this example, on an equivalent basis, the hydroxyl/acid ratio equals 0.975.

### EXAMPLE 3 (COMPARATIVE)

Again rosin from the same lot of Pamite 90 was used as in the previous examples and 1954.0 grams of rosin was charged into a 3 liter glass reactor and melted at 170° C. under nitrogen. After melting the rosin, 5.9 grams of Ethanox 323 and 4.7 grams of Irgamod 195 were added and the mixture again heated to 200° C. At 200° C., 195.4 grams of monopentaerythritol was added and the batch heated to 270° C. under nitrogen sparge. The batch was held at 270° C. until the acid number was less than 14. Thirty minutes prior to discharging the batch two antioxidants were added, 5.0 grams of Irganox 565 (Ciba-Geigy) and 13.3 grams of distearyl-thio-dipropionate (Structol). In this example, on an equivalent basis, the hydroxyl/acid ratio equals 0.950.

### EXAMPLE 4

Rosin from the same lot of Pamite 90 was used as in the previous examples and 1925.0 grams of rosin was charged into a 3 liter glass reactor and melted at 170° C. under nitrogen. After melting the rosin, 5.8 grams of Ethanox 323 and 4.6 grams of Irgamod 195 were added. At 200° C., 214.0 grams of monopentaerythritol was added, followed by 39.0 grams of succinic acid. Again, the top reaction temperature is 270° C. and a nitrogen sparge was used and the batch held at this temperature until the acid number was less than 14. Thirty minutes prior to discharging the batch two antioxidants were added, 5.0 grams of Irganox 565 (Ciba-Geigy) and 13.3 grams of distearyl-thio-dipropionate (Structol). In this example, the hydroxyl/acid ratio for rosin and monopentaerythritol alone is 1.057. When the equivalents of succinic acid are considered, the hydroxyl acid ratio is 0.951.

### EXAMPLE 5

Rosin from the same lot of Pamite 90 was again used as in the previous examples with 1953.6 grams of rosin charged into a 3 liter glass reactor and melted at 170° C. under nitrogen. After melting the rosin, 5.9 grams of Ethanox 323 and 4.7 grams of Irgamod 195 were added. At 200° C., 213.6 grams of monopentaerythritol was added followed by 41.8 grams of adipic acid. Again, the top reaction temperature is 270° C. and a nitrogen sparge was used and the batch was held at this temperature until the acid number was less than 14. Thirty minutes prior to discharging the batch two antioxidants were added, 5.0 grams of Irganox 565 (Ciba-Geigy) and 13.3 grams of distearyl-thio-dipropionate (Structol). In this example, the hydroxyl/acid ratio for rosin and monopentaerythritol alone is 1.040. When the equivalents of adipic acid are considered, the hydroxyl acid ratio is 0.950.

### EXAMPLE 6

Rosin from the same lot of Pamite 90 was again used as in the previous examples with 1953.6 grams of rosin charged into a 3 liter glass reactor and melted at 170° C. under nitrogen. After melting the rosin, 5.9 grams of Ethanox 323 and 4.7 grams of Irgamod 195 were added. At 200° C., 205.5 grams of monopentaerythritol was added, followed by 55.0 grams of Versatic 10 acid. Again, the top reaction temperature is 270° C. and a nitrogen sparge is used and the batch was held at this temperature until the acid number was less than 14. Thirty minutes prior to discharging the batch two antioxidants were added, 5.0 grams of Irganox 565 (Ciba-Geigy) and 13.3 grams of distearyl-thio-dipropionate (Structol). In this example, the hydroxyl/acid ratio for rosin and monopentaerythritol alone is 1.000. When the equivalents of Versatic 10 acid are considered, the hydroxyl acid ratio becomes 0.948. Versatic 10 (Hexion Specialty Chemicals) acid is a tertiary, aliphatic, monocarboxylic acid.

### EXAMPLE 7

Rosin from the same lot of Pamite 90 was again used as in the previous examples with 1954.0 grams of rosin charged into a 3 liter glass reactor and melted at 170° C. under nitrogen. After melting the rosin, 5.9 grams of Ethanox 323 and 4.7 grams of Irgamod 195 were added. At 200° C., 209.0 grams of monopentaerythritol was added, followed by 35.6 grams of isophthalic acid. Again, the top reaction temperature is 270° C. and a nitrogen sparge is used and the batch held at this temperature until the acid number was less than 14. Thirty minutes prior to discharging the batch two antioxidants were added, 5.0 grams of Irganox 565 (Ciba-Geigy) and 13.3 grams of distearyl-thio-dipropionate (Structol). The hydroxyl/acid ratio for rosin and monopentaerythritol alone is 1.017. When the equivalents of isophthalic acid are considered, the hydroxyl acid ratio is 0.950.

### EXAMPLE 8

In this example, a different tall oil rosin, R-24 (MeadWestvaco) with an acid number of 173.4 and a Gardner color (molten) of 8.7 was used. In a 4 liter standard glass reactor 2664.1 grams of R-24 was charged and melted at 170° C. under a nitrogen blanket. Upon melting, 8.0 grams of Ethanox 323 and 6.4 grams of Irgamod 195 were added and the mixture heated to 200° C. where 305.0 grams of monopentaerythritol was added. After charging the monopentaerythritol, 261.8 grams of Chinese dimer tall oil fatty acid (Hexion Specialty Chemicals, AN=188.6) was charged and the contents heated to 280° C. under nitrogen sparge. The batch was held at this temperature until the acid number was less than 16. Thirty minutes prior to discharging the batch two antioxidants were added, 5.0 grams of Irganox 565 (Ciba-Geigy) and 13.3 grams of distearyl-thio-dipropionate (Structol). The hydroxyl/acid ratio for rosin, monopentaerythritol and dimer fatty acid is 0.984.

### EXAMPLE 9

In this example, 1953.6 grams of R-24 is charged to a 3 liter glass reactor and melted at 170° C. under nitrogen. Following the rosin addition, 5.9 grams of Ethanox 323, 4.7 grams of Irgamod 195 and 27.5 grams of benzoic acid were charged and heated to 200° C. where 209.0 grams of monopentaerythritol were added. At this stage the batch is heated to 260° C. under a nitrogen sparge and the batch was held at this temperature until the acid number was less than 14. Thirty minutes prior to discharging the batch two antioxidants were added, 5.0 grams of Irganox 565 (Ciba-Geigy) and 13.3 grams of distearyl-thio-dipropionate (Structol). The hydroxyl/acid ratio for rosin, monopentaerythritol and benzoic acid is 0.980.

### EXAMPLE 10 (COMPARATIVE)

Using a sample of Pamite 90 (Eastman Chemical) tall oil rosin with a neat Gardner color of 9.0, an acid number of 173 and a softening point of 74° C., 1877 grams were charged into a 3 liter glass resin reactor and heated to 160° C. under a nitrogen blanket for melt-out. After melting, the rosin was heated to 205° C. and 186 grams of fumaric acid was charged and held at this temperature for 1.5 hours. After the completed hold time, 7.5 grams of Ethanox 323 and 4.8 grams of Irgamod 195 were charged to the reactor. After mixing, 320 grams of mono-pentaerythritol was charged and the temperature set-point changed to 270° C. with a four hour ramp rate. In addition, the nitrogen blanket was switched to a nitrogen sparge for the remainder of the batch. The batch was held at 270° C. until the acid number was below 20. Thirty minutes prior to discharging the batch, 4.8 grams of Lowinox TBM6 (Great Lakes Chemical) antioxidant was added. On an equivalents basis, the hydroxyl/acid ratio is equal to 1.050.

### EXAMPLE 11 (COMPARATIVE)

Using a sample of Pamite 90 (Eastman Chemical) tall oil rosin with a neat Gardner color of 9.0, an acid number of 173 and a softening point of 74° C., 1877 grams was charged into a 3 liter glass resin reactor and heated to 160° C. under a nitrogen blanket for melt-out. After melting, the rosin was heated to 205° C. and 174 grams of fumaric acid was charged and held at this temperature for 1.5 hours. After the completed hold time, 7.2 grams of Ethanox 323 and 4.8 grams of Irgamod 195 were charged to the reactor. After mixing, 342 grams of mono-pentaerythritol was charged and the temperature set-point changed to 260° C. with a four hour ramp rate. In addition, the nitrogen blanket was switched to a nitrogen sparge for the remainder of the batch. Upon heat-up and when the batch reached 212° C., 42 grams of adipic acid was charged. The batch was held at 260° C. until the acid number was below 25. Thirty minutes prior to discharging the batch, 4.8 grams of Lowinox TBM6 (Great Lakes Chemical) antioxidant was added. On an equivalent basis, the hydroxyl/acid ratio is equal to 1.075.

### EXAMPLE 12

Using a sample of Pamite 90 (Eastman Chemical) tall oil rosin with a neat Gardner color of 9.0, an acid number of 173 and a softening point of 74° C., 1877 grams was charged into a 3 liter glass resin reactor and heated to 160° C. under a nitrogen blanket for melt-out. After melting, the rosin was heated to 195° C. and 186 grams of fumaric acid was charged and held at this temperature for 1.5 hours. After the completed hold time, 7.2 grams of Ethanox 323 and 4.8 grams of Irgamod 195 was charged to the reactor. After mixing, 316 grams of mono-pentaerythiritol was charged and the temperature set-point changed to 270° C. with a four hour ramp rate. In addition, the nitrogen blanket was switched to a nitrogen sparge for the remainder of the batch. Upon heat-up and when the batch reached 204° C., 42 grams of adipic acid was charged. The batch was held at 270° C. until the acid number was below 27. Thirty minutes prior to discharging the batch, 4.8 grams of Lowinox TBM6 (Great Lakes Chemical) antioxidant was added. On an equivalents basis, the hydroxyl/acid ratio is equal to 0.972.

### EXAMPLE 13

Using a sample of Pamite 90 (Eastman Chemical) tall oil rosin with a neat Gardner color of 9.0, an acid number of 173 and a softening point of 74° C., 1877 grams was charged into a 3 liter glass resin reactor and heated to 160° C. under a nitrogen blanket for melt-out. After melting, the rosin was heated to 195° C. and 186 grams of fumaric acid was charged and held at this temperature for 1.5 hours. After the completed hold time, 7.2 grams of Ethanox 323 and 4.8 grams of Irgamod 195 were charged to the reactor. After mixing, 320 grams of mono-pentaerythritol was charged and the temperature set-point changed to 270° C. with a four hour ramp rate. In addition, the nitrogen blanket was switched to a nitrogen sparge for the remainder of the batch. Upon heat-up and when the batch reached 202° C., 42 grams of succinic acid was charged. The batch was held at 270° C. until the acid number was below 27. Thirty minutes prior to discharging the batch, 4.8 grams of Lowinox TBM6 (Great Lakes Chemical) antioxidant was added. On an equivalent basis, the hydroxyl/acid ratio is equal to 0.972.

Physical properties for the resins in the above examples are shown in the following table. Acid number and softening point measurements are consistent with ASTM D-1639 and ASTM E 28, respectively. Color measurement on the neat resins was done with a Gardner LCM colorimeter, while color measurement on resin solutions was done with a Gardner Delta Illuminated color comparator.

| | | Softening | Resin | Rosin | |
|---|---|---|---|---|---|
| | | Point | Color | Color | |
| | Acid | (° C., | (Gardner, | (Gardner, | Δ |
| Examples | Number | R&B) | neat) | neat) | Color |
| Example 1 | 11.3 | 98.3 | 6.3 | 8.3 | 2.0 |
| (Comparative) | | | | | |
| Example 2 | 12.4 | 100.0 | 6.4 | 8.3 | 1.9 |
| (Comparative) | | | | | |
| Example 3 | 14.0 | 97.5 | 5.3 | 8.3 | 3.0 |
| (Comparative) | | | | | |
| Example 4 | 11.1 | 99.4 | 5.1 | 8.3 | 3.2 |
| Example 5 | 10.5 | 105.2 | 5.4 | 8.3 | 2.9 |
| Example 6 | 10.8 | 98.6 | 5.1 | 8.3 | 3.2 |
| Example 7 | 12.9 | 102.1 | 6.1 | 8.3 | 2.2 |
| Example 8 | 15.9 | 85.0 | 5.2 | 8.7 | 3.5 |
| Example 9 | 13.3 | 96.5 | 5.3 | 8.7 | 3.4 |

Delta (Δ) color is the difference in resin color between the starting rosin and the modified rosin ester resin.

The above examples illustrate that an equivalent acid excess, whether generated by rosin, an aliphatic or aromatic diacid, or aliphatic or aromatic mono-acids, result in a significant improvement in Gardner color as compared to the starting rosin.

| | | Softening | Resin Color | Rosin | |
|---|---|---|---|---|---|
| | | Point | (Gardner, | Color | |
| | Acid | (° C., | xylene | (Gardner, | Δ |
| Examples | Number | R&B) | solution) | neat) | Color |
| Example 10 | 16.7 | 137 | 8.5 | 9.0 | 1.5 |
| (Comparative) | | | | | |
| Example 11 | 23.1 | — | 9.5 | 9.0 | −0.5 |
| (Comparative) | | | | | |
| Example 12 | 26.3 | 158 | 6.5 | 9.0 | 2.5 |
| Example 13 | 25.6 | 152 | 7.0 | 9.0 | 2.0 |

The above examples also serve to illustrate that an equivalent acid excess, generated by reacting rosin with an alpha, beta-unsaturated dicarboxylic acid, such as fumaric acid, and in the presence of an acid functional organic compound, metal phosphonate stabilizer/catalyst, phenol sulfide compound and polyol result in a significant improvement in Gardner color as compared to the starting rosin.

1. A process to produce of a rosin ester resin comprising the steps of:
(a) contacting a molten rosin with a polyol having hydroxyl functionality to form a first reactant mixture; and
(b) contacting the first reactant mixture with an amount of 0.5 to 10 weight %, by weight of all reactants, of an acid functional organic compound selected from the group consisting of aromatic monofunctional acids, aromatic polyfimctional acid, aliphatic monofunctional, aliphatic polyfunctional acids, natural fatty acids, synthetic fatty acids, polymerized rosin, rosin resin, and combinations thereof, to form a final reactant mixture,
wherein the final reactant mixture does not contain a stoichiometric excess of hydroxyl functionality.

2. The process of claim 1 comprising contacting a stabilizer, a catalyst or a phenol sulfide compound with the molten resin in prior to contacting the molten resin with the polyol.

3. The process of claim 2 wherein the catalyst comprises metal derivatives of hindered mono or dibasic phenol substituted phosphonic acids, and the phenyl sulfide is nonylphenol disulfide.

4. The process of claim 1 wherein the polyol is selected from the group consisting of ethylene glycol, diethylene glycol, glycerol, mono-pentaerythritol, tech-pentaerythritol, dipentaerythritol, trimethylolethane, trimethylolpropane, manitol, sorbitol and combinations thereof.

5. The process of claim 1 wherein the acid functional organic compound is an aromatic monofunctional acid selected from the group consisting of benzoic acid, 2-methylbenzoic acid, 3-methylbenzoic acid, 4-methylbenzoic acid, 2-ethylbenzoic acid, 3-ethylbenzoic acid, 4-ethylbenzoic acid, salicylic acid, 4-hydroxy benzoic acid, 1-naphtoic acid and combinations thereof.

6. The process of claim 1 wherein the acid functional organic compound is an aromatic difunctional acid selected from the group consisting of phthalic acid, isophtalic acid, terephthalic acid and combinations thereof.

7. The process of claim 1 wherein the acid functional organic compound is an aliphatic monocarboxylic acid selected from the group consisting of butanoic acid, pentanoic acid, pivalic acid, hexanoic acid, neodecanoic acid and combinations thereof.

8. The process of claim 1 wherein the acid functional organic compound is an aliphatic dicarboxylic acid selected from the group consisting of succinic acid, glutaric acid, adipic acid, pimelic acid, and combinations thereof.

9. The process of claim 2 wherein:
the rosin is a tall oil rosin;
the catalyst comprises metal derivatives of hindered mono or dibasic phenol substituted phosphonic acids;
the phenyl sulfide is nonylphenol disulfide; and
the polyol comprises glycerol, pentaerythritol or mono-pentaerythritol; and
the acid fimctional organic compound comprises succinic acid, glutaric acid, adipic acid or pimelic acid.

10. The process of claim 9 wherein, based upon the total weight of all reactants:
the tall oil rosin is present in an amount of from 82 to 92 weight %;
the catalyst is present in an amount of from 0.1 to 0.3 weight %;
the nonylphenol disulfide is present in an amount of from 0.1 to 0.4 weight %; and
the polyol comprises mono-pentaerythritol and is present in an amount of from 8 to 11 weight %,
the acid functional organic compound comprises succinic acid and is present in an amount of 1 to 3 weight %.

11. The process of claim 1 wherein the rosin ester has a first Gardner color number, and wherein the molten rosin has a second Gardner color number, wherein the first Gardner color number is less than the second Gardner number.

12. A process to produce of a rosin ester resin comprising:
(a) contacting a molten rosin with an alpha,-beta unsaturated carboxylic acid to form a first reactant mixture;
(b) contacting the first reactant mixture with a polyol having hydroxyl functionality to form a second reactant mixture; and
(c) contacting the second reactant mixture with an amount 0.5 to 10 weight %, by weight of all reactants, of an acid functional organic compound selected from the group consisting of aromatic monofunctional acids, aromatic polyfunctional acid, aliphatic monofunctional, aliphatic polyfunctional acids, natural fatty acids, synthetic fatty acids, polymerized rosin, rosin resin, and combinations thereof to form a final reactant mixture;
wherein the final reaction mixture does not contain a stoichiometric excess of hydroxyl functionality.

13. The process of claim 12 comprising contacting a stabilizer, a catalyst or a phenol sulfide compound with the first reactant mixture prior to contacting the first reactant with the polyol.

14. The process of claim 13 wherein the catalyst comprises metal derivatives of hindered mono or dibasic phenol substituted phosphonic acids, and the phenyl sulfide is nonylphenol disulfide.

15. The process of claim 12 wherein the polyol is selected from the group consisting of ethylene glycol, diethylene glycol, glycerol, mono-pentaerythritol, tech-pentaerythritol, dipentaerythritol, trimethylolethane, trimethylolpropane, manitol, sorbitol and combinations thereof.

16. The process of claim 12 wherein the acid functional organic compound is an aromatic monofunctional acid selected from the group consisting of benzoic acid, 2-methylbenzoic acid, 3-methylbenzoic acid, 4-methylbenzoic acid, 2-ethylbenzoic acid, 3-ethylbenzoic acid, 4-ethylbenzoic acid, salicylic acid, 4-hydroxy benzoic acid, 1-naphtoic acid and combinations thereof.

17. The process of claim 12 wherein the acid functional organic compound is an aromatic difunctional acid selected from the group consisting of phthalic acid, isophtalic acid, terephthalic acid and combinations thereof.

18. The process of claim 12 wherein the acid functional organic compound is an aliphatic monocarboxylic acid selected from the group consisting of butanoic acid, pentanoic acid, pivalic acid, hexanoic acid, neodecanoic acid and combinations thereof.

19. The process of claim 12 wherein the acid functional organic compound is an aliphatic dicarboxylic acid selected from the group consisting of succinic acid, glutaric acid, adipic acid, pimelic acid, and combinations thereof.

20. The process of claim 13 wherein:
the rosin is a tall oil rosin;
alpha,-beta unsaturated carboxylic acid is fumaric acid;
the catalyst comprises metal derivatives of hindered mono or dibasic phenol substituted phosphonic acids;
the phenyl sulfide is nonylphenol disulfide; and
the polyol comprises glycerol, pentaerythritol or mono-pentaerythritol; and
the acid functional organic compound comprises succinic acid, glutaric acid, adipic acid or pimelic acid.

21. The process of claim 20 wherein, based upon the total weight of all reactants:
the rosin is present in an amount of from 75 to 80 weight %;
the alpha,-beta unsaturated carboxylic acid is present in an amount of 6 to 9 weight %
the catalyst is present in an amount of from 0.1 to 0.3 weight %;
the phenol sulfide is present in an amount of from 0.2 to 0.4 weight %; and
the polyol is present in an amount of from 10 to 14 weight %,
the acid functional organic compound comprises adipic acid in an amount of 1 to 3 weight %.

22. The process of claim 12 wherein the rosin ester has a first Gardner color number, and wherein the molten rosin has a second Gardner color number, wherein the first Gardner color number is less than the second Gardner number.
